(19) United States
(12) Patent Application Publication
(10) Pub. No.: US 2022/0026658 A1
(43) Pub. Date: Jan. 27, 2022

(54) FIBER OPTIC CABLE ASSEMBLY WITH FURCATION AND METHOD OF MAKING SAME

(71) Applicant: CORNING RESEARCH & DEVELOPMENT CORPORATION, Corning, NY (US)

(72) Inventor: Max Wiktor Gajek, Lodz (PL)

(21) Appl. No.: 17/498,457

(22) Filed: Oct. 11, 2021

Related U.S. Application Data
(63) Continuation of application No. PCT/US20/29185, filed on Apr. 22, 2020.
(60) Provisional application No. 62/837,158, filed on Apr. 22, 2019.

(51) Int. Cl. G02B 6/44

(52) U.S. Cl. CPC G02B 6/4471; G02B 6/441

(57) ABSTRACT

A method of furcating a fiber optic cable is disclosed. The method includes positioning an inlet fanout tube and a furcation housing spaced from an end of the cable, removing a protective jacket from the cable to define an exposed portion of a plurality of cable optical fibers, providing a plurality of pre-manufactured connector assemblies that each have an optical connector, splicing the cable optical fibers to a respective one of the connector assemblies to define a splicing region; and repositioning the furcation housing and the inlet fanout tube so that the splicing region is positioned within the furcation housing and the inlet fanout tube covers a section of the exposed portion of the plurality of cable optical fibers. Fiber optic cable assemblies formed by the method are also disclosed.

### PRIORITY APPLICATION

This application is a continuation of International Application No. PCT/US20/29185, filed on Apr. 22, 2020, which claims the benefit of priority to U.S. Application No. 62/837,158, filed on Apr. 22, 2019, both applications being incorporated herein by reference.

### TECHNICAL FIELD

This disclosure relates generally to optical connectivity, and more particularly to a furcation for a fiber optic cable assembly and a method for making the furcation.

### BACKGROUND

Optical fibers are useful in a wide variety of applications, including the telecommunications industry for voice, video, and data transmissions. The benefits of optical fiber are well known and include higher signal-to-noise ratios and increased bandwidth compared to conventional copper-based transmission technologies. To meet modern demands for increased bandwidth and improved performance, telecommunication networks are increasingly using optical fiber to connect equipment. For example, optical fibers may be used in data center environments or the like to provide connections between equipment within the data center. As another example, telecommunication companies that provide service to end subscribers are increasingly providing optical fiber connectivity closer to the end subscribers. These initiatives include fiber-to-the-node (FTTN), fiber-to-the-premises (FTTP), fiber-to-the-home (FTTH), and the like (generally described as FTTx).

In an FTTx network, fiber optic cables are used to carry optical signals to various distribution points and, in some cases, all the way to end subscribers. For example, FIG. 1 is a schematic diagram of an exemplary FTTx network 10 that distributes optical signals generated at a switching point 12 (e.g., a central office of a network provider) to subscriber premises 14. Optical line terminals (OLTs; not shown) at the switching point 12 convert electrical signals to optical signals. Fiber optic feeder cables 16 then carry the optical signals to various local convergence points 18, which act as locations for splicing and making cross-connections and interconnections. The local convergence points 18 often include splitters to enable any given optical fiber in the fiber optic feeder cable 16 to serve multiple subscriber premises 14. As a result, the optical signals are “branched out” from the optical fibers of the fiber optic feeder cables 16 to optical fibers of distribution cables 20 that exit the local convergence points 18.

At network access points closer to the subscriber premises 14, some or all of the optical fibers in the distribution cables 20 may be accessed to connect to one or more subscriber premises 14. Drop cables 22 extend from the network access points to the subscriber premises 14, which may be single-dwelling units (SDU), multi-dwelling units (MDU), businesses, and/or other facilities or buildings. A conversion of optical signals back to electrical signals may occur at the network access points or at the subscriber premises 14.

There are many different network architectures, and the various tasks required to distribute optical signals (e.g., splitting, splicing, routing, connecting subscribers) can occur at several locations. Regardless of whether a location is considered a local convergence point, network access point, subscriber premise, or something else, fiber optic equipment is used to house components that carry out one or more of the tasks. The term “terminal” will be used in this disclosure to generically refer to such equipment, which may include fiber distribution hubs (FDH), cabinets, closures, network interface devices, distributor frames, etc. At various terminals in the optical fiber network 10, the incoming optical signal is transmitted through a multi-fiber optical cable, i.e., the fiber optic cable includes a plurality of optical fibers within an outer sheath or jacket, with each optical fiber carrying an optical signal. Depending on the particular application, there may be a need to furcate the incoming fiber optic cable into a plurality of individual optical fibers, which are then optically coupled to other components of the fiber optic network, such as various optical fiber modules, devices, cables (e.g., distribution cables), etc.

Processes for furcating a fiber optic cable are generally known in the industry. For example, one method for furcating a fiber optic cable includes stripping the outer jacket of the fiber optic cable to expose a length of the individual optical fibers carried by the cable. If the individual optical fibers are jacketed and/or coated, any such coating(s) and jacket may also be removed to expose bare optical fibers. The bare optical fibers are then pushed through a length of fanout tubing. The ends of the bare optical fibers that extend through the fanout tubing are then subjected to a connectorization process so as to terminate in an optical fiber connector. While the current methods for furcating a multi-fiber optical cable generally achieve their intended purpose, drawbacks exist, and consequently manufacturers continually strive to improve the process.

By way of example, one drawback is that existing furcation processes tend to generate excessive scrap material, which is costly from both a lost-product standpoint and from a lost-labor standpoint. More particularly, due to tight tolerances in user network specifications, if there is an error in any one of the multiple optical fibers of the furcation (e.g., the length between the furcation point and the fiber optic connector is too long, too short, etc.), the entire furcation must be scrapped, and the process started over again. For example, the connectorization process for a furcated cable, whether done in field conditions or a factory, is often a manual process that depends on the individual skill and experience of the technician that performs the process. Accordingly, there may be a significant amount of variation in this process that contributes to the furcation falling outside of the tolerance specifications, resulting in a reworking of the entire furcation.

Another drawback is that the process of pushing an optical fiber through a fanout tube has a practical limitation in the maximum length of the fanout tube. For example, in current processes the fanout tube has a maximum length of about 2.5 meters. Over this length, it becomes exceedingly difficult to push the optical fiber due to the inherent frictional resistance to the pushing movement of the fiber through the fanout tube. As network designs continue to evolve, it may be desirable to increase the distance between the furcation point and the fiber optic connector beyond this length. Current furcation processes will not be able to meet this demand, and thus will need to evolve as well.

### SUMMARY

A method of furcating an end of a fiber optic cable carrying a plurality of cable optical fibers is disclosed. The method includes positioning an inlet fanout tube and a furcation housing on the fiber optic cable at a location spaced from the end of the fiber optic cable; removing a protective jacket from the fiber optic cable adjacent the end of the fiber optic cable to define an exposed portion of the plurality of cable optical fibers carried by the fiber optic cable, the exposed portion of the plurality of cable optical fibers defining a free end of each cable optical fiber in the plurality of cable optical fibers; and providing a plurality of pre-manufactured connector assemblies, each connector assembly including at least one assembly optical fiber and an optical connector coupled to the at least one assembly optical fiber. Each assembly optical fiber has a first end and a second end, and each optical connector is coupled to the second end or second ends of the corresponding at least one assembly optical fiber. The method further includes: splicing each of the free ends of the cable optical fibers to the first end of a respective one of the assembly optical fibers to form a splicing region; and repositioning the furcation housing and the inlet fanout tube along the fiber optic cable so that the splicing region is positioned within the furcation housing and the inlet fanout tube covers a section of the exposed portion of the plurality of cable optical fibers that extend beyond the furcation housing.

In some embodiments, each connector assembly of the plurality of connector assemblies further includes an assembly jacket surrounding the corresponding at least one assembly optical fiber. The method may further include positioning respective outlet fanout tubes on each of the connector assemblies at a location spaced from the first end or first ends of the corresponding at least one assembly optical fiber; removing the assembly jacket from each of the plurality of connector assemblies adjacent the first end or first ends of the corresponding at least one assembly optical fiber to define an exposed portion of the at least one assembly optical fiber; and repositioning the outlet fanout tubes along the respect connector assemblies so that an end of each of the outlet fanout tubes is positioned in the furcation housing. In this embodiment, repositioning the outlet fanout tubes may be such that each of the outlet fanout tubes covers a section of the exposed portion of the corresponding at least one assembly optical fiber that extends beyond the furcation housing.

In one embodiment, removing the protective jacket from the fiber optic cable further includes exposing a portion of the strength members (e.g., aramid yarns) carried by the fiber optic cable. Similarly, removing the assembly jacket from each of the plurality of connector assemblies may include exposing a portion of the strength members carried by the connector assemblies.

The method may further include supplying bonding agent to the furcation housing to secure the plurality of cable optical fibers of the fiber optic cable and the assembly optical fibers of the connector assemblies to the furcation housing. The bonding agent may also secure the strength members of the multi-fiber cable and/or strength members of the connector assemblies to the furcation housing.

In another embodiment, splicing each of the free ends of the cable optical fibers to the first end of a respective one of the assembly optical fibers includes individually splicing a single fiber of the cable optical fibers to a corresponding single fiber of the assembly optical fibers. In another embodiment, splicing each of the free ends of the cable optical fibers to the first end of a respective one of the assembly optical fibers includes mass fusion splicing an optical fiber ribbon of cable optical fibers to a corresponding optical fiber ribbon of the assembly optical fibers, wherein the optical fiber ribbon of the cable optical fibers and the optical fiber ribbon of the assembly optical fibers each include a plurality of optical fibers.

Embodiments of fiber optic cable assemblies are also disclosed. According to one embodiment, a fiber optic cable assembly includes a fiber optic cable having a plurality of cable optical fibers and a protective jacket surrounding the plurality of cable optical fibers, wherein a portion of the protective jacket has been removed adjacent an end of the fiber optic cable to define an exposed portion of the plurality of cable optical fibers. The expose portion of the plurality of cable optical fibers defines a free end of each cable optical fiber in the plurality of cable optical fibers. The fiber optic cable assembly also includes a plurality of pre-manufactured connector assemblies, wherein each connector assembly includes at least one assembly and an optical connector coupled to the at least one assembly optical fiber. Each assembly optical fiber has a first end and a second end, and each optical fiber is coupled to the second end or second ends of the corresponding at least one assembly optical fiber. The fiber optic cable assembly also includes a splicing region where the free ends of each of the plurality of cable optical fibers is spliced to the first end of a respective one of the assembly optical fibers. The fiber optic cable assembly further includes a furcation housing having a first end, a second end, and an internal passage extending therebetween, wherein the plurality of cable optical fibers extends through the first end of the furcation housing, the plurality of connector assemblies extends through the second end of the furcation housing, and the splicing region is positioned in the internal passage. The fiber optic cable assembly also includes an inlet fanout tube having a first end, a second end, and an internal passage extending therebetween, wherein the first end of the inlet fanout tube receives the fiber optic cable and the second end of the inlet fanout tube is coupled to the first end of the furcation housing, and wherein the inlet fanout tube covers a section of the exposed portion of the cable optical fibers that extends beyond the furcation housing. A bonding agent is disposed in the furcation housing to secure the plurality of cable optical fibers and the plurality of connector assemblies to the furcation housing.

In one embodiment, each connector assembly of the plurality of connector assemblies further includes an assembly jacket surrounding the corresponding at least one assembly optical fiber. A portion of the assembly jacket has been removed adjacent the first end or first ends of the corresponding at least one assembly optical fiber to define an exposed portion of the at least one assembly optical fiber. In this embodiment, the fiber optic cable assembly further includes a plurality of outlet fanout tubes each having a first and, a second end, and an internal passage extending therebetween. The first end of each outlet fanout tube in the plurality of outlet fanout tubes is positioned in the furcation housing, and the second end of each outlet fanout tube in the plurality of outlet fanout tubes receives a respective one of the plurality of connector assemblies. Each of the outlet fanout tubes covers a section of the exposed portion of the corresponding at least one assembly optical fiber that extends beyond the furcation housing.

In an exemplary embodiment, the inlet fanout tube and the furcation housing are sized so as to be slidable over an outer surface of the fiber optic cable. Similarly, the plurality of outlet fanout tubes may be sized so as to be slidable over an outer surface of the connector assemblies. In one embodiment, the inlet fanout tube and the furcation housing form a monolithic body, such as through a molding process. The multi-fiber cable may include cable strength members, and the plurality of connector assemblies may include assembly strength members, wherein the cable strength members and the assembly strength members are secured within the furcation housing by the bonding agent.

In another embodiment, the splicing region includes individually splicing free ends of a single fiber of the cable optical fibers to free ends of a corresponding single fiber of the assembly optical fibers. In another embodiment, the splicing region includes mass fusion splicing free ends of an optical fiber ribbon of cable optical fibers to a corresponding free ends of an optical fiber ribbon of the assembly optical fibers, wherein the optical fiber ribbon of the cable optical fibers and the optical fiber ribbon of the assembly optical fibers each include a plurality of optical fibers.

In still another embodiment, a kit for furcating a fiber optic cable carrying a plurality of optical fibers is disclosed. The kit includes an inlet fanout tube having a first end, a second end, and an internal passage extending therebetween, wherein the inlet fanout tube is sized so as to receive the fiber optic cable therethrough and be slidable along an outer surface of the fiber optic cable; a furcation housing having a first end, a second end, and an internal passage extending therebetween, wherein the furcation housing is sized so as to receive the fiber optic cable therethrough and be slidable along an outer surface of the fiber optic cable; a plurality of pre-manufactured connector assemblies, wherein each connector assembly includes at least one assembly optical fiber and an optical connector coupled to the at least one assembly optical fiber, wherein each assembly optical fiber has a first and a second end, and wherein each optical connector is coupled to the second end or second ends of the at least one assembly optical fiber; and a plurality of outlet fanout tubes each having a first end, a second end, and an internal passage extending therebetween, and wherein each of the outlet fanout tubes is sized so as to receive a respective one of the plurality of connector assemblies therethrough and be slidable along an outer surface of the respective connector assembly.

In yet another embodiment, a method of furcating an end of a fiber optic cable carrying a plurality of cable optical fibers is disclosed. The method includes: removing a protective jacket from the fiber optic cable adjacent the end of the fiber optic cable to define an exposed portion of the plurality of cable optical fibers carried by the fiber optic cable, the exposed portion of the plurality of cable optical fibers defining a free end of each cable optical fiber in the plurality of cable optical fibers; providing a plurality of pre-manufactured connector assemblies, each connector assembly including at least one assembly optical fiber, an optical connector coupled to the at least one assembly optical fiber, and an assembly jacket surrounding the corresponding at least one assembly optical fiber, wherein each assembly optical fiber has a first end and a second end, and wherein each optical connector is coupled to the second end or second ends of the corresponding at least one assembly optical fiber; positioning respective outlet fanout tubes on each of the connector assemblies at a location spaced from the first end or first ends of the corresponding at least one assembly optical fiber; splicing each of the free ends of the cable optical fibers to the first end of a respective one of the assembly optical fibers to form a splicing region; repositioning the outlet fanout tubes along the respective connector assemblies so that an end of each of the outlet fanout tubes is positioned in the furcation housing; and supplying a bonding agent to the furcation housing to secure the plurality of cable optical fibers and the plurality of connector assemblies to the furcation housing.

In another embodiment, splicing each of the free ends of the cable optical fibers to the first end of a respective one of the assembly optical fibers includes individually splicing a single fiber of the cable optical fibers to a corresponding single fiber of the assembly optical fibers. In another embodiment, splicing each of the free ends of the cable optical fibers to the first end of a respective one of the assembly optical fibers includes mass fusion splicing an optical fiber ribbon of cable optical fibers to a corresponding optical fiber ribbon of the assembly optical fibers, wherein the optical fiber ribbon of the cable optical fibers and the optical fiber ribbon of the assembly optical fibers each include a plurality of optical fibers.

In another embodiment, a fiber optic cable assembly is disclosed. The fiber optic cable assembly includes: a fiber optic cable including a plurality of cable optical fibers and a protective jacket surrounding the plurality of cable optical fibers, wherein a portion of the protective jacket has been removed adjacent an end of the fiber optic cable to define an exposed portion of the plurality cable optical fibers, the exposed portion of the plurality of cable optical fibers defining a free end of each cable optical fiber in the plurality of cable optical fibers; a plurality of pre-manufactured connector assemblies, each connector assembly including at least one assembly optical fiber, an optical connector coupled to the at least one assembly optical fiber, and an assembly jacket surrounding the at least one assembly optical fiber, wherein: each assembly optical fiber has a first end and a second end; each optical connector is coupled to the second end or second ends of the corresponding at least one assembly optical fiber; and a portion of the assembly jacket of each connector assembly has been removed adjacent the first end or first ends of the corresponding at least one assembly optical fiber to define an exposed portion of the at least one optical fiber; a plurality of outlet fanout tubes each having a first end, a second end, and an internal passage extending therebetween; a splicing region where the free ends of each of the plurality of cable optical fibers is spliced to the first end of a respective one of the assembly optical fibers; a furcation housing having a first end, a second end, and an internal passage extending therebetween, wherein: the plurality of cable optical fibers extends through the first end of the furcation housing, the plurality of connector assemblies extends through the second end of the furcation housing, and the splicing region is positioned in the internal passage; the first end of each outlet fanout tube in the plurality of outlet fanout tubes is positioned in the furcation housing and the second end of each outlet fanout tube in the plurality of outlet fanout tubes receives a respective one of the plurality of connector assemblies; each outlet fanout tube in the plurality of outlet fanout tubes covers a section of the exposed portion of the corresponding at least one assembly optical fiber that extends beyond the furcation housing; and a bonding agent in the furcation housing to secure the plurality of cable optical fibers and the plurality of connector assemblies to the furcation housing.

Additional features and advantages will be set forth in the detailed description which follows, and in part will be readily apparent to those skilled in the technical field of optical connectivity. It is to be understood that the foregoing general description, the following detailed description, and the accompanying drawings are merely exemplary and intended to provide an overview or framework to understand the nature and character of the claims.

### BRIEF DESCRIPTION OF THE DRAWINGS

The accompanying drawings are included to provide a further understanding and are incorporated in and constitute a part of this specification. The drawings illustrate one or more embodiment(s), and together with the description serve to explain principles and operation of the various embodiments. Features and attributes associated with any of the embodiments shown or described may be applied to other embodiments shown, described, or appreciated based on this disclosure.

FIG. 1 is a schematic diagram of an exemplary FTTx network;

FIG. 2 is a furcation in accordance with an exemplary embodiment of the disclosure;

FIGS. 3A-3H illustrate a method of forming a furcation in a multi-fiber cable in accordance with an exemplary embodiment of the disclosure;

FIG. 4 illustrates an inlet fanout tube and furcation housing in accordance with an alternative embodiment of the disclosure;

FIG. 5 illustrates a perspective view of a furcation in a multi-fiber cable where optical fiber ribbons are mass fusion spliced together and each optical fiber ribbon splice is protected by a low-profile splice protector;

FIG. 6 illustrates a cross-sectional view of the low profile splice protector of FIG. 5; and

FIGS. 7A and 7B illustrate perspective views of a method of installing the low-profile splice protector onto the spliced optical fiber ribbons of FIG. 5.

### DETAILED DESCRIPTION

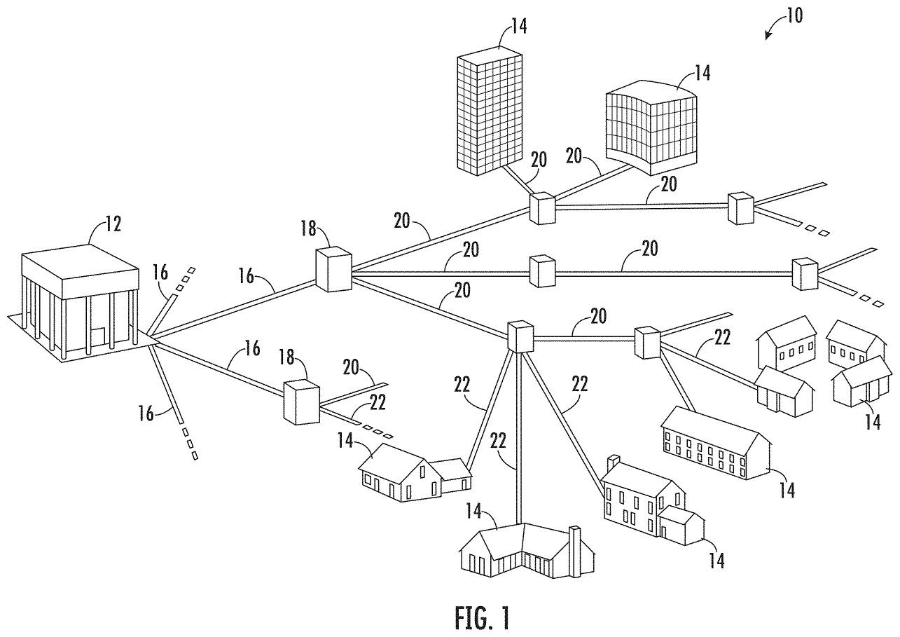

Various embodiments will be further clarified by examples in the description below. In general, the description generally relates to an improved method of furcating a multi-fiber optical cable to produce a plurality of optical fibers each being terminated with a fiber optic connector (i.e., a fiber optic cable assembly). The resulting furcated fiber optic cable assembly/furcation may exist in a terminal of a fiber optic network. By way of example, the terminal may be used in FTTx networks, such as the FTTx network 10 illustrated in FIG. 1, at local convergence points 18 or network access points, or even in enterprise networks, such as in data center environments. Thus, it should be understood that the method and resulting furcation may in fact be used in a wide variety of different equipment for all different types of fiber optic networks.

The terms “upstream” and “downstream” in this disclosure are terms of convenience for describing the arrangement of elements relative to each other. In particular, as will be described in greater detail below, the furcation methods involve splices between ends of optical fibers. The terms “upstream” and “downstream” are in regard to contemplated splice location (or actual splice location, if the splices have been performed when discussing these terms). As such, the terms “upstream” and “downstream” are not associated with a direction of data transmission in the optical fibers.

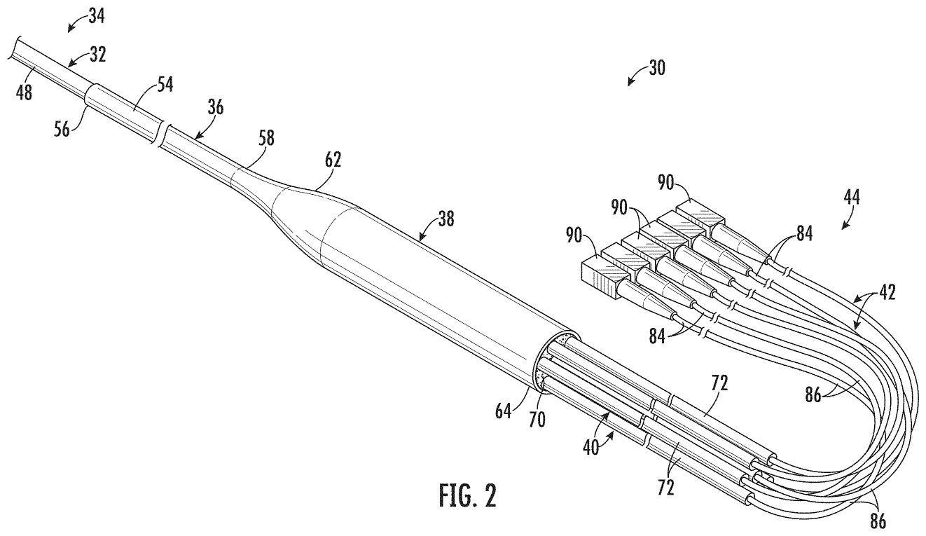

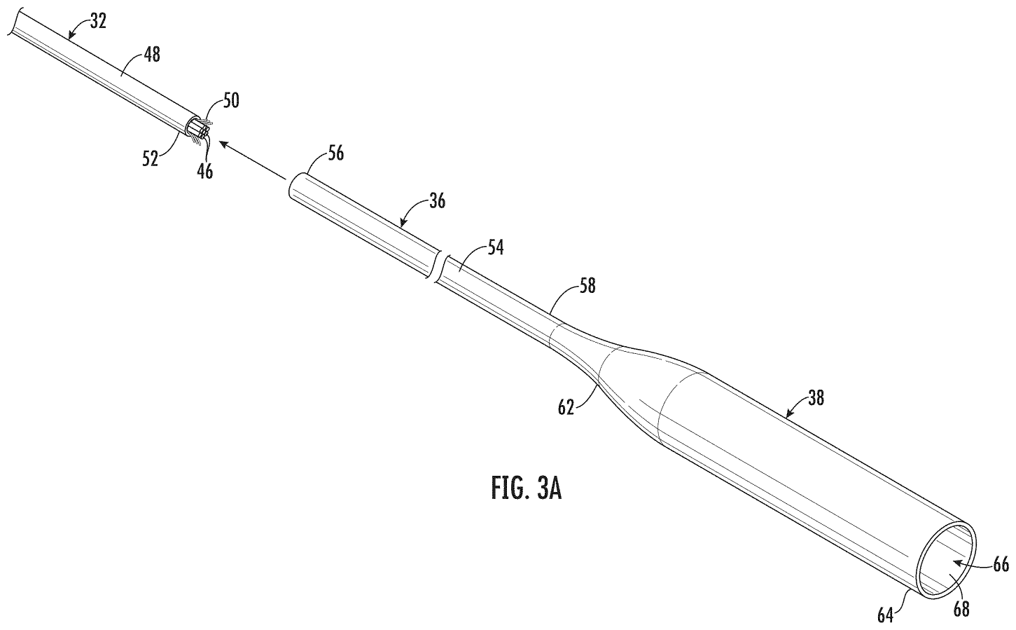

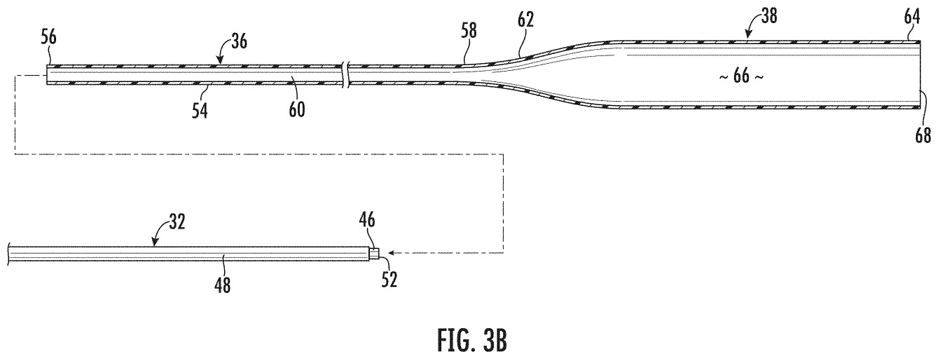

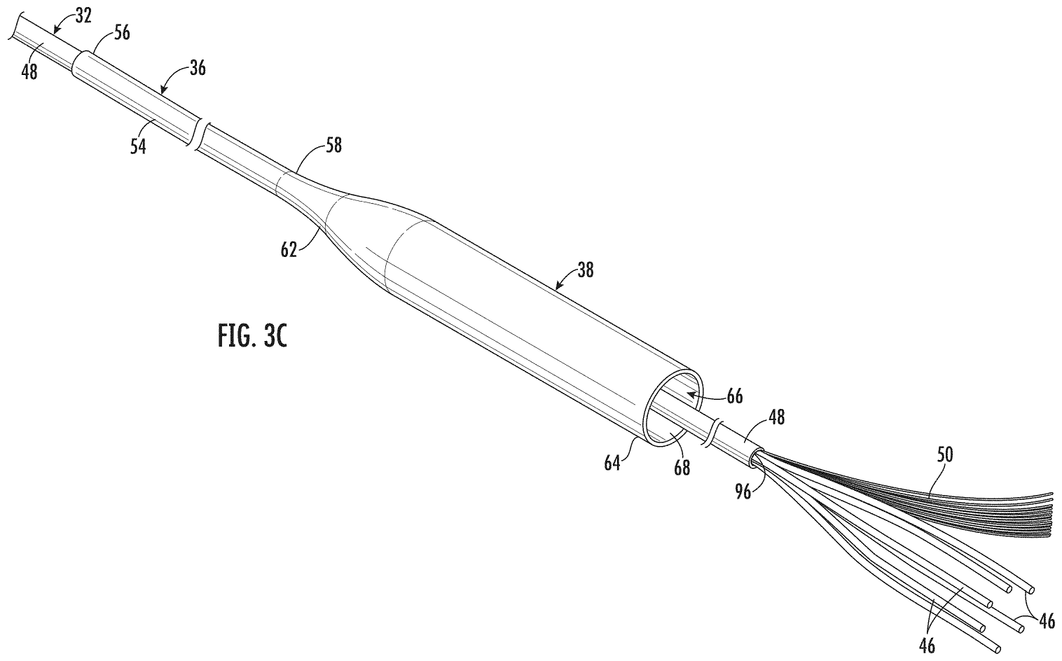

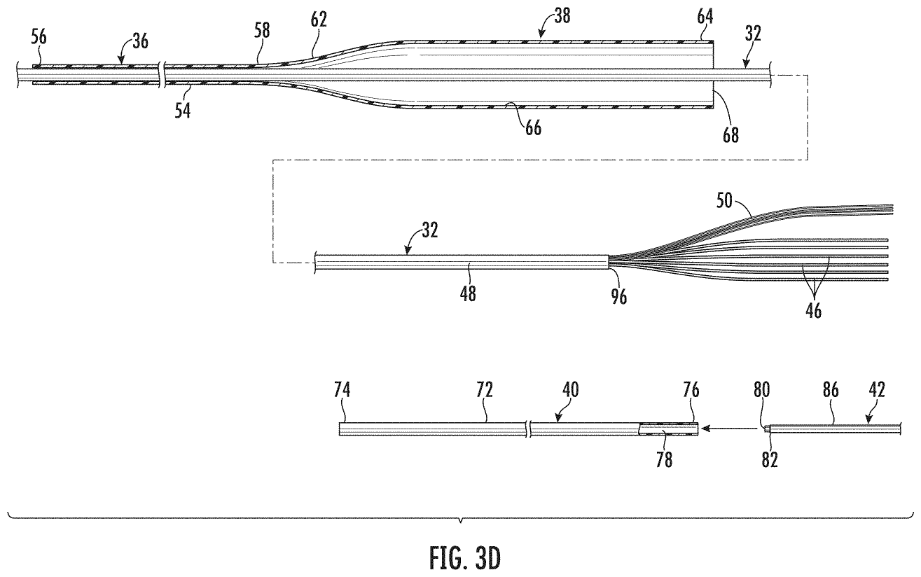

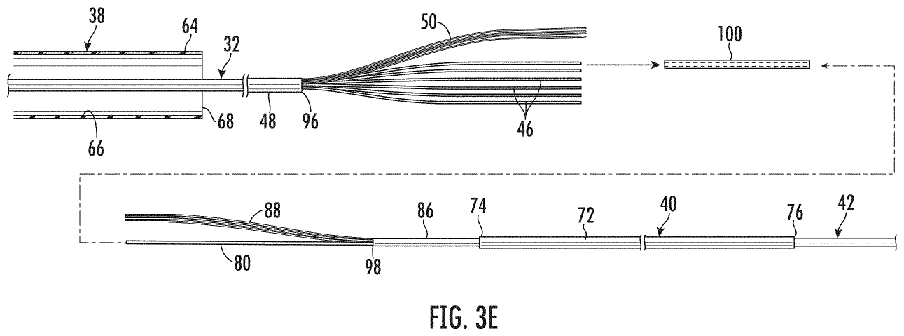

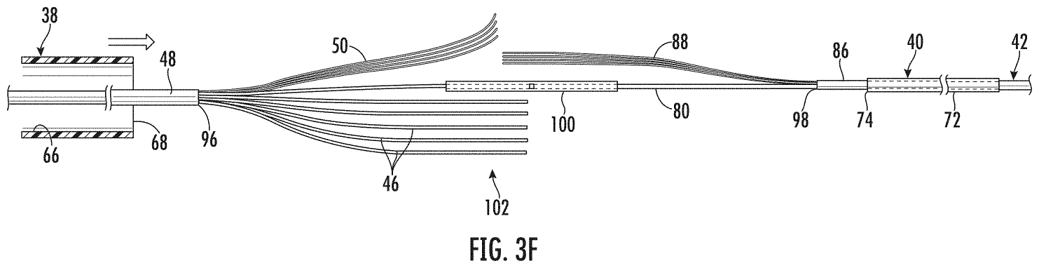

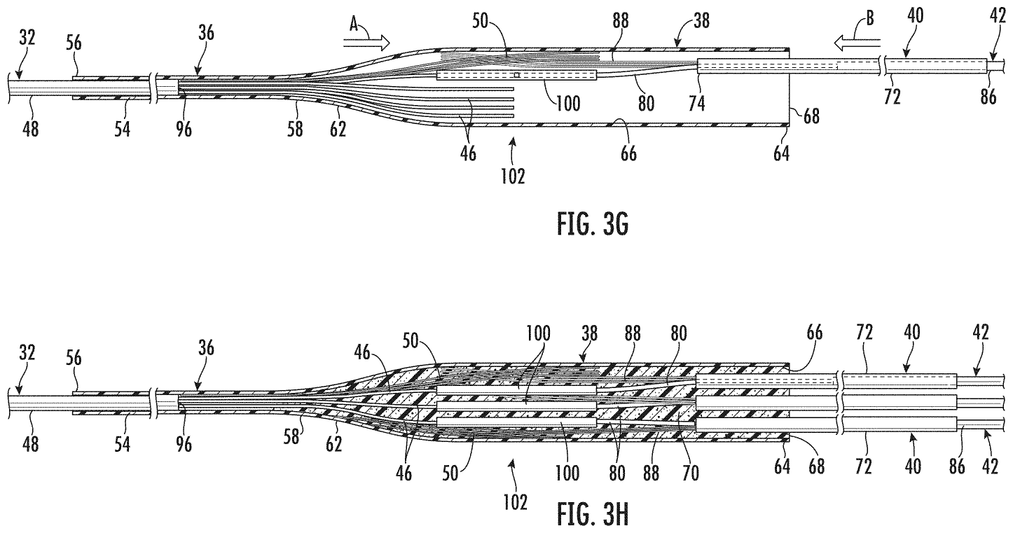

A furcation 30 in accordance aspects of the disclosure is illustrated in FIG. 2. The furcation 30 includes a fiber optic cable in the form of a multi-fiber cable 32 at a first inlet or downstream end 34 (“first end”) of the furcation 30, an inlet protective tube 36 (referred to herein as “inlet fanout tube” or simply “fanout tube”), a furcation housing 38, a plurality of outlet protective fanout tubes 40 (referred to herein as “outlet fanout tubes” or simply “fanout tubes”), and a plurality of connector assemblies 42 (referred to herein as “pigtail assemblies” or simply “pigtails”) at a second outlet or upstream end 44 (“second end”) of the furcation 30. The multi-fiber cable 32 is well known in the optical communications industry and includes a plurality of cable optical fibers 46 (FIGS. 3A-3C, referred to herein simply as “optical fibers”) surrounded by an outer protective sheath or jacket 48. The optical fibers 46 may be bare optical fibers, coated optical fibers (e.g., bare optical fibers covered by one or more acrylic coating layers), tight buffered optical fibers (e.g., coated optical fibers covered by thermoplastic material), or may be part of cable sub-assemblies or sub-units having an outer protective jacket. Additionally, the multi-fiber cable 32 or the individual cable sub-units may include strength members, such as a plurality of generally longitudinally extending aramid yarns 50. The multi-fiber cable 32 terminates at an end 52 (“first end 52” or “free end 52”) at which the furcation 30 is located.

The inlet fanout tube 36 includes an elongate cylindrical housing or body 54 having a first end 56 configured to receive the multi-fiber cable 32, a second end 58 configured to couple to the furcation housing 38, and an internal passage 60 extending between the first end 56 and the second end 58. The fanout tube 36 is configured to generally provide a protective outer cover to the optical fibers that extend within the fanout tube 36. The internal passage 60 is sized to be generally larger than the multi-fiber cable 32, with the first end 56 being just slightly larger than the multi-fiber cable 32. For reasons described more fully below, this allows the inlet fanout tube 36 to slide over the outer surface of the multi-fiber cable 32, yet provide a relatively snug fit between the first end 56 of the fanout tube 36 and the outside of the multi-fiber cable 32, as illustrated in FIG. 2 for example. Fanout tubing is generally well known and may be formed from a suitable plastic, such as PVC.

The furcation housing 38 may take the form of a generally elongate cylinder having a first end 62 coupled to the second end 58 of the inlet fanout tube 36, a second end 64, and an internal passage 66 extending between the first end 62 and the second end 64. As explained in more detail below, the furcation housing 38 generally covers and protects splices formed between the optical fibers 46 of the multi-fiber cable 32 and the pigtails 42. In an exemplary embodiment, the first end 62 of the furcation housing 38 may have a tapered configuration such that the outer dimension of the housing converges toward the outer dimension of the inlet fanout tube 36. In one embodiment, the inlet fanout tube 36 and the furcation housing 38 may be an integral or monolithic body (e.g., an integrally molded body). In an alternative embodiment, however, the inlet fanout tube 36 and the furcation housing 38 may be separate elements which are subsequently coupled together, such as through bonding or other means. Additionally, while the furcation housing 38 is described as being cylindrical, the furcation housing may have other shapes and configurations.

When the furcation housing 38 is coupled to the inlet fanout tube 36, the internal passage 60 of the fanout tube 36 is in communication with the internal passage 66 of the furcation housing 38. This allows the optical fibers 46 from the multi-fiber cable 32 to extend into the furcation housing 38. The second end 64 of the furcation housing 38 may be generally circular in cross section and be sized to accommodate the plurality of outlet fanout tubes 40 that extend within the opening 68 at the second end 64. For example, the furcation housing 38 may be sized to accommodate up to twelve outlet fanout tubes 40 (thus twelve pigtails 42). Additionally, the internal passage 66 of the furcation housing is filled with a bonding agent 70 to secure the multi-fiber cable 32 and the pigtails 42 together within the furcation housing 38. The bonding agent 70 may include a wide range of adhesives, including epoxy resins, hot melt adhesives, polyurethanes, and other glues and agents. The furcation housing 38 may be formed from any suitable material, such as suitable plastic materials.

The outlet fanout tubes 40 are each similar to the inlet fanout tube 36 and include an elongate cylindrical housing 72 having a first end 74 configured to be received in the opening 68 of the furcation housing 38 and be coupled thereto by the bonding agent 70 (FIG. 2), a second end 76 (FIG. 3D) configured to receive a pigtail 42, and an internal passage 78 extending between the first end 74 and the second end 76. The outlet fanout tubes 40 are configured to generally provide a protective outer cover to portions of the pigtails 42 that extend within the fanout tubes 40. The internal passage 78 is sized to be generally larger than the pigtails 42, with the first end 74 being just slightly larger than the outer dimension of a pigtail 42. For reasons described more fully below, this allows the outlet fanout tubes 40 to slide over the outer surface of the pigtails 42, yet provide a relatively snug fit between the second end 76 of the fanout tubes 40 and the outer surface of the pigtails 42, as illustrated in FIG. 2 for example. Similar to above, the fanout tubes 40 are generally well known and may be formed from a suitable plastic, such as PVC.

Pigtails 42 are generally well known in the optical fiber industry and include a length of one or more optical fibers terminated with an optical connector. In the embodiment shown, the pigtails include a single optical fiber 80 having a first end 82 and a second end 84. The optical fiber 80 may be a bare glass fiber or a glass fiber with one or more protective coating layers (e.g., an acrylic coating and a tight buffer). In some embodiments, the optical fiber 80 may be within an outer jacket and referred to as “jacketed optical fiber”. The jacketed optical fiber may further include strength members, such as aramid yarns. This type of pigtail 42 is illustrated in the figures and therefore includes an outer jacket 86 and aramid yarns 88. As discussed in more detail below, the first end 82 of the optical fiber 80 may be spliced to a respective optical fiber 46 of the multi-fiber cable 32 in the furcation housing 38. The optical connector 90 is coupled to the the second end 84 of the optical fiber 80. The optical connector 90 may include a wide range of optical connectors, including without limitation LC, SC, ST, and MU-type connectors. The optical connector 90 is in the form of a simplex, single-fiber optical connector in the embodiment shown because, again, the pigtails 42 each include a single optical fiber 80. Pigtails with more than one optical fiber 80 may include duplex optical connectors or multi-fiber optical connectors.

In one aspect of the disclosure, the pigtails 42 are high-quality, low-cost pre-manufactured fiber optic components. In this regard, the connectorization process for coupling the optical connector 90 to the optical fiber 80 may be performed in a controlled environment, such as in a factory setting. Moreover, in the factory setting automated processes may be implemented that provide high precision and consistency for the manufacture of the pigtails 42. The use of automated processes may overcome the quality variations typically associated with manual connectorization processes of current techniques. Additionally, the automated processes may manufacture pigtails 42 at relatively high throughput rates, which in conjunction with the methods described herein reduce the overall costs of forming furcations in multi-fiber optical cables. Because the pigtails 42 are pre-manufactured components, the optical fiber 80 of the pigtails 42 may have any desired length. Thus, for example, the pigtails 42 may be anywhere between less than 0.5 meters to over 10 meters in length. Unlike current furcation processes, there is no length limitation imposed on the distance between the furcation point and the optical connector 90. The splicing of pigtails 42 to the optical fibers 46 of the multi-fiber cable 32 may obviate the fiber pushing methods used in current techniques, and thus overcome the limitations of current methods.

FIGS. 3A-3H Illustrate a process for forming a furcation 30 in a multi-fiber optical cable 32 (“multi-fiber cable 32”) in accordance with an embodiment of the disclosure. In a first step and as illustrated in FIGS. 3A and 3B, the inlet fanout tube 36 and the furcation housing 38 may be slid over the first end 52 of the multi-fiber cable 32 such that the inlet fanout tube 36 and the furcation housing 38 are generally downstream of the first end 52 of the multi-fiber cable 32. In doing so, a portion of the multi-fiber cable 32 extends through the internal passage 60 of the inlet fanout tube 36, through the internal passage 66 of the furcation housing 38, and through the opening 68 at the second end 64 of the furcation housing 38. A working length of the multi-fiber cable 32 may extend beyond the second end 64 of the furcation housing 38 sufficient to achieve the splicing process, as discussed below. As mentioned above, the inlet fanout tube 36 and the furcation housing 38 may be slid over the first end 52 of the multi-fiber cable 32 as an assembly (e.g., these elements form an integral or monolithic body). Alternatively, the inlet fanout tube 36 may be slid over the first end 52 of the multi-fiber cable 32 first, and subsequently followed by sliding the furcation housing 38 over the first end 52 of the multi-fiber cable 32. The inlet fanout tube 36 and the furcation housing 38 may be coupled together after being placed over the multi-fiber cable 32.

In a subsequent step and as illustrated in FIG. 3C, at least a portion of the working length of the multi-fiber cable 32 extending beyond the second end 64 of the furcation housing 38 may have its outer jacket 48 removed to expose the optical fibers 46 and associated aramid yarns 50. If the optical fibers 46 are themselves jacketed (e.g., part of cable sub-units), those jackets may similarly be removed to expose the optical fibers 46 and aramid yarns 50. And if the optical fibers 46 are themselves covered by one or more protective coating layers, any such coating layers may be stripped to expose bare glass portions of the optical fibers 46. Thus, in any case, after this process, the end of multi-fiber cable 32 will include a plurality of bare optical fibers 46 and aramid yarns 50 exposed beyond a splicing end 96 of the jacket 48 of the multi-fiber cable 32. The length of exposed optical fibers 46 and aramid yarns 50 may be longer than the furcation housing 38 due to the limitations of stripping and/or splicing devices. In other words, a relatively long length of the exposed bare glass may be required for any of the following: stripping the jacket 48 from the multi-fiber cable 32, stripping the protective coating layer(s) from the optical fibers 46, splicing the exposed optical fibers 46 to the optical fibers 80. The furcation may adequately secure the multi-fiber cable 32 to the pigtails 42 without needing such a relatively long length.

In light of the above, in a subsequent step and as illustrated in FIGS. 3D and 3E, the plurality of outlet fanout tubes 40 may be slid over respective first ends 82 of the optical fibers 80 such that the outlet fanout tubes 40 are generally upstream of the first ends 82. In doing so, a portion of the pigtails 42 extends through the second ends 76 of the outlet fanout tubes 40, through the internal passage 78, and beyond the first ends 74 of the outlet fanout tubes 40. A working length of the pigtails 42 may extend beyond the first ends 74 of the outlet fanout tubes 40 sufficient to achieve the splicing process, as discussed below. While FIG. 3D illustrates only a single outlet fanout tube 40 and pigtail 42, it will be understood that this process may be repeated for each of the pigtails 42 that are to be optically coupled to a respective one of the optical fibers 46 of the multi-fiber cable 32.

As also illustrated in FIG. 3E, in a subsequent step at least a portion of the working length of the pigtails 42 extending beyond the first end 74 of the outlet fanout tubes 40 may have their outer jackets 86 removed to expose the optical fibers 80 and aramid yarns 88. After this process, the ends of the pigtails 42 will include a bare optical fiber 80 and aramid yarns 88 exposed beyond a splicing end 98 of the jacket 86 of the pigtails 42. Due to the splicing process and typical devices for stripping the jacket 86 from the pigtails 42, the length of exposed optical fiber 80 and yarns 88 may be longer than needed to accomplish the splicing and may be longer than the furcation housing 38.

In a subsequent step and as illustrated in FIGS. 3E and 3F, with the inlet fanout tube 36 and furcation housing 38 downstream of the first end 52 of the multi-fiber cable 32, with the outlet fanout tubes 40 upstream of the first ends 82 of the optical fibers 80, and with the optical fibers 46 of the multi-fiber cable 32 and the optical fibers 80 of the pigtails 42 exposed, a splicing process between the optical fibers 46 and optical fibers 80 may be performed. For example, the first ends 52 of the optical fibers 46 may each be fusion spliced or mechanically spliced to a respective one of the first ends 82 of the optical fibers 80. For embodiments involving fusion splices, a plurality of splicing tubes 100 may be provided to protect the joints between the pairs of optical fibers 46, 80.

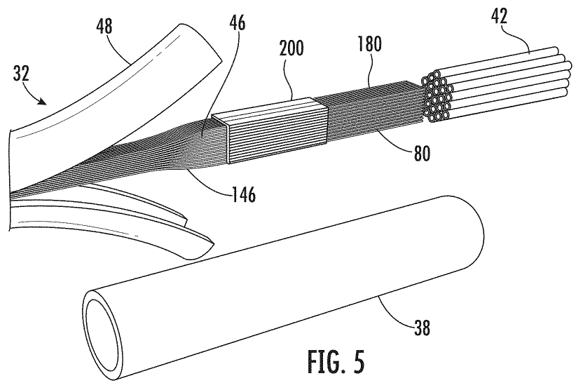

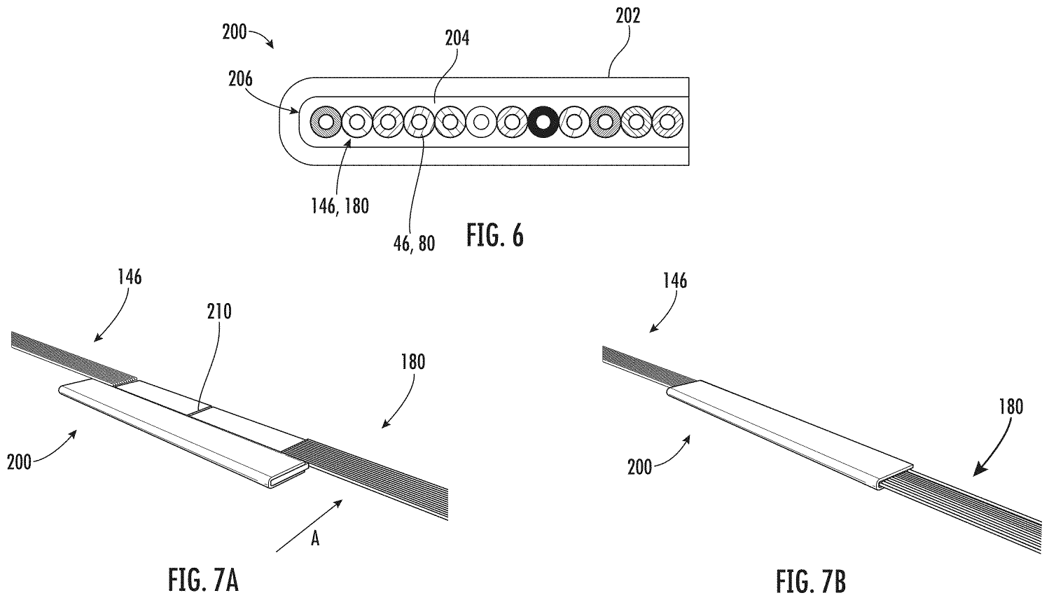

In some embodiments, as shown in FIG. 5, optical fiber ribbons 146, 180 (also referred to as “ribbons”) of optical fibers 46, 80 respectively are mass fusion spliced together to form a splice joint 210 (FIG. 7A, also referred to as a “splicing region”) by a splicing process described herein or by methods known in the art. In such embodiments where ribbons 146, 180 are fusion spliced together, a splice protector 200 (FIGS. 5 and 6) is used to protect the splice joint 210 (FIG. 7A) between the ribbons 146, 180. The splice protector 200 and the splice joint 210 are housed within furcation housing 38. FIG. 5 illustrates a respective splice protector 200 for each splice joint 210. In alternative embodiments, the splice joints 210 (each associated with two of the ribbons 146, 180) may be covered by a common splice protector (not shown).

As shown in greater detail in FIG. 6, splice protector 200 is a low-profile splice protector that comprises a U-shaped stainless-steel reinforcement shell 202 to protect the splice joint 210 (FIG. 7A) housed within the shell 202 along at least three sides of the splice joint 210. It is contemplated that in alternate embodiments, alternative shapes of splice protector 200 may be used to protect the splice joint 210 of ribbons 146, 180 along at least three sides of the splice joint 210. Splice protector 200 includes a thermoplastic material 204 within cavity 206 of splice protector 200 to encapsulate the splice joint 210 and portions of bare fibers 46, 80 of ribbons 146, 180 adjacent to the joints (FIGS. 7A and 7B).

As shown in FIGS. 7A and 7B, the installation of splice protector 200 onto the joints of optical fiber ribbons 146, 180 requires sliding the splice protector 200 onto the splice joint 210 in direction A such that the thermoplastic material 204 within cavity 206 of splice protector 200 encapsulates the splice joint 210 and portions of optical fiber ribbons 146, 180. While a single splice protector 200 is shown in FIGS. 5-7B, it is within the scope of the present disclosure that multiple splice protectors 200 may be used to protect multiple splice joints 210 of multiple pairs of optical fiber ribbons that are positioned within furcation housing 38. Splice protectors 200 are low profile and compact and therefore, occupy less area within the furcation housing 38, which in turn, necessitates smaller furcation housings 38 and yield space efficient cable assemblies.

Although an inlet fanout tube is not shown in FIGS. 5-7B, it will be appreciated that such an element providing a snug fit with the jacket 48 of the multi-fiber cable 32 and being coupled to the furcation housing 38 may be provided similar to other embodiments discussed (those having inlet fanout tube 36). A heat shrink tube (not shown) may even be provided in some embodiments to serve as such an inlet fanout tube. The heat shrink tube may conform to the jacket 48 and the furcation housing 38 in such embodiments.

The splicing process is generally well understood in the optical fiber industry and thus will not be explained in more detail herein. After the splicing process, the furcation 30 will include a splicing region 102 generally where multiple pairs of the optical fibers 46, 80 are optically coupled together. This process optically couples the connectors 90 of the pigtails 42 with at least one of the optical fibers 46 carried by the multi-fiber cable 32.

Once the splicing process has been completed, in a subsequent step and as illustrated in FIG. 3G, the furcation housing 38 and inlet fanout tube 36 may be slid back over the outer surface of the multi-fiber cable 32 and in the upstream direction toward the splicing region 102. This movement may continue until the splicing region 102 is generally positioned within the internal passage 66 of the furcation housing 38. This movement of the furcation housing 38 is illustrated by arrow A in FIG. 3G. Similarly, each of the outlet fanout tubes 40 may be slid back over the outer surface of the pigtails 42 and in the downstream direction toward the splicing region 102. This movement may continue until the first ends 74 of the outlet fanout tubes 40 are adjacent the splicing region 102. This movement of the outlet fanout tubes 40 is illustrated by arrow B in FIG. 3G. Once the splicing region 102 is positioned within the furcation housing 38 and the first ends 74 of the outlet fanout tubes 40 are adjacent the splicing region 102, a portion of the outlet fanout tubes 40 may extend through the opening 68 and reside within the internal passage 66 of the furcation housing 38.

In some applications, it may be desirable to minimize the size of the furcation housing 38 in the formation of the furcation 30. Thus, a smaller length and smaller diameter of the furcation housing 38 may be preferred. For example, the furcation housing 38 may have a diameter of between about 10 mm and about 16 mm and have a length of between about 50 mm and about 70 mm. In one exemplary embodiment, the furcation housing may have a diameter of about 12 mm and a length of about 60 mm. It should be recognized that other diameters and lengths for furcation housing 38 are possible. Due to the stripping process and current devices, the amount of bare optical fiber between the splicing ends 96 and 98 may be appreciable. Thus, if the bare optical fiber between the splicing ends 96, 98 were to be covered by the furcation housing 38, the size of the furcation housing 38 would similarly be significant. For example, it is estimated that such a furcation housing would be between about 120 mm and about 150 mm or more. If one uses a smaller furcation housing 38 to, for example, just protect the splicing region 102, then there would be a significant amount of bare optical fiber 46, 80 exposed beyond the ends of the furcation housing 38 left unprotected, and therefore subject to increased damage and breakage.

Aspects of the present disclosure address this situation by using one or more fanout tubes on at least one side of the furcation housing 38 (i.e., on the downstream and/or upstream side) to cover exposed optical fibers extending outside the furcation housing. In a preferred embodiment, one or more fanout tubes may be provided on both sides of the furcation housing 38 (i.e., there is bare optical fiber exposed on both sides of the furcation housing 38). Thus, the inlet fanout tube 36 may be configured to protect the bare optical fibers 46 that extend outside of a shortened furcation housing 38 on a downstream side, and a plurality of outlet fanout tubes 40 may be configured to protect the bare optical fibers 80 that extend outside the furcation housing 38 on an upstream side. In this way, a smaller, more compact furcation housing may be used to cover the splicing region 102 and the fanout tubes 36, 40 may be used to protect bare optical fiber 46, 80 of the multi-fiber cable 32 and the pigtails 42. In an exemplary embodiment, the inlet fanout tube 36 may have a length of between about 50 mm and about 70 mm. The outlet fanout tubes 40 may be shorter, such as between about 20 mm to about 40 mm in length. The lengths of the inlet fanout tube 36 and outlet fanout tubes 40 ensure that bare optical fibers 46, 80 are protected. Aspects of the disclosure are not limited to these dimensions and it should be recognized that other lengths of the fanout tubes 36, 40 are also possible.

In a further step of the method and as illustrated in FIG. 3H, the various elements of the furcation 30 may be secured together to thereby provide a strong connection between the multi-fiber cable 32 and the pigtails 42. This may include not only the optical fibers 46, 80 and splicing tubes 100, but also the aramid yarns 50, 88 associated with the multi-fiber cable 32 and connector pigtails 42. The inclusion of the aramid yarns 50, 88 within the furcation housing 38 may increase the strength of the joint between the multi-fiber cable 32 and the pigtails 42. More particularly, a bonding agent 70 may be introduced into the internal passage 66 of the furcation housing 38 to secure the furcation elements together. In one embodiment, for example, an epoxy resin may be injected into the internal passage 66 via the opening 68 in the second end 64 of the furcation housing 38. The epoxy resin may substantially fill (e.g., 80% fill, preferably 90% fill, and more preferably 98% fill) the internal passage 66 so as to encapsulate the first ends 74 of the outlet fanout tubes 40 that reside within the furcation housing 38. In another embodiment, a heat activated bonding agent, such as a pelletized hot melt adhesive, may be introduced into the internal passage 66 of the furcation housing 38 and subsequently heated to cause the bonding agent to flow and bind the furcation elements together within the furcation housing 38. It should be understood that other bonding agents, such as various glues, heat or light activated bonding agents, etc. may be used to secure the furcation elements together.

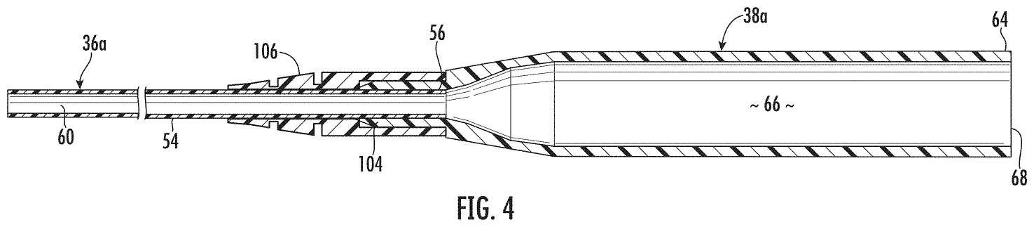

FIG. 4 illustrates an inlet fanout tube 36a and furcation housing 38a in accordance with an alternate embodiment of the disclosure. In the embodiment described above, the inlet fanout tube 36 and the furcation housing 38 were formed as an integral or monolithic body. Aspects of the disclosure, however, are not so limited. In the embodiment shown in FIG. 4, the inlet fanout tube 36a and furcation housing 38a are separate elements which are subsequently coupled together. More particularly the first end 62 of the furcation housing 38a includes a nose 104 for capturing the second end 58 of the inlet fanout tube 36a. The second end 58 of the inlet fanout tube 36a may be, for example, bonded to the nose 104 to secure the connection. Moreover, an elastic strain-relief sleeve 106 may be disposed about the nose 104 and a portion of the inlet fanout tube 36a adjacent the second end 58. In an exemplary embodiment, the inlet fanout tube 36a, furcation housing 38a, and sleeve 106 may be coupled together to form an assembly prior to those elements being slid over the end 52 of the multi-fiber cable 32 as described above. In an alternative embodiment, however, these components may be first slid over the multi-fiber cable 32 then coupled together to form the assembly. Thus, the inlet fanout tube and the furcation housing may have various forms and be formed through various processes all within the scope of the present disclosure.

To overcome many of the drawbacks of current furcation processes, a splicing process using pre-manufactured pigtails is used to form an optical connection with the optical fibers carried in the multi-fiber cable. The splices between the pigtails and the optical fibers of the multi-fiber cable are protected by a relatively small furcation housing. The inlet fanout tube and furcation housing are slid over the multi-fiber cable. Similarly, the outlet fanout tubes are slid over the pigtails. The optical fibers are stripped and spliced together at a splicing region. The furcation housing and the inlet fanout tube are then slid back along the multi-fiber cable so that the furcation housing covers the splicing region. The outlet fanout tubes are then slid back along the pigtails so that the end of the fanout tubes are positioned in the furcation housing. Any bare optical fiber that is exposed outside of the furcation housing on either the downstream side or the upstream side of the furcation housing may be protected by fanout tubing. This allows the size of the furcation housing to me minimized.

The use of pigtails in the furcation process provides several benefits. For example, pigtails are relatively low-costs connector assemblies that are made in a factory setting and include a specified length of optic fiber having one end terminated with a fiber optic connector. Thus, by using pigtails the connectorization process may be taken from field conditions to a factory setting, where more standardized processes maybe implemented for producing higher quality optical connections. For example, highly-controllable and repeatable automated processes may be used to perform the connectorization process and produce high-quality pigtails. This avoids the manual and highly variable connectorization step used in current furcation processes.

Additionally, the use of pigtails allows the distance between the furcation point and the fiber optic connectors of the furcation to be of any desired length. In other words, the process of pushing a bare optical fiber through a fanout tube is avoided by using pigtails and the splicing process. Accordingly, the practical limitations in the length of the upstream leg of the furcation is overcome and the upstream leg may have a length desired or required by a specific application.

In another aspect of the disclosure, a kit may be provided for forming a furcation in a multi-fiber cable 32 in a field setting. The kit may include an inlet fanout tube 36, a furcation housing 38, a plurality of pigtails 42, and a plurality of outlet fanout tubes 40. The inlet fanout tube 36 and the furcation housing 38 may form a monolithic body. The kit may further include a bonding agent 70 and a plurality of splicing tubes 100. With this kit, a field technician will be able to furcate the multi-fiber cable 32 in the manner described above. Such a kit would be very convenient for field technicians and includes most everything needed to complete the furcation.

While the present disclosure has been illustrated by the description of specific embodiments thereof, and while the embodiments have been described in considerable detail, it is not intended to restrict or in any way limit the scope of the appended claims to such detail. The various features discussed herein may be used alone or in any combination within and between the various embodiments. Additional advantages and modifications will readily appear to those skilled in the art. The disclosure in its broader aspects is therefore not limited to the specific details, representative apparatus and methods and illustrative examples shown and described. Accordingly, departures may be made from such details without departing from the scope of the disclosure.

What is claimed is:

1. A method of furcating an end of a fiber optic cable carrying a plurality of cable optical fibers, the method comprising:
positioning an inlet fanout tube and a furcation housing on the fiber optic cable at a location spaced from the end of the fiber optic cable;
removing a protective jacket from the fiber optic cable adjacent the end of the fiber optic cable to define an exposed portion of the plurality of cable optical fibers carried by the fiber optic cable, the exposed portion of the plurality of cable optical fibers defining a free end of each cable optical fiber in the plurality of cable optical fibers;
providing a plurality of pre-manufactured connector assemblies, each connector assembly including at least one assembly optical fiber and an optical connector coupled to the at least one assembly optical fiber, wherein each assembly optical fiber has a first end and a second end, and wherein each optical connector is coupled to the second end or second ends of the corresponding at least one assembly optical fiber;
splicing each of the free ends of the cable optical fibers to the first end of a respective one of the assembly optical fibers to form a splicing region; and
repositioning the furcation housing and the inlet fanout tube along the fiber optic cable so that the splicing region is positioned within the furcation housing and the inlet fanout tube covers a section of the exposed portion of the plurality of cable optical fibers that extends beyond the furcation housing.

2. The method of claim 1, wherein each connector assembly of the plurality of connector assemblies further includes an assembly jacket surrounding the corresponding at least one assembly optical fiber, the method further comprising:
positioning respective outlet fanout tubes on each of the connector assemblies at a location spaced from the first end or first ends of the corresponding at least one assembly optical fiber;
removing the assembly jacket from each of the plurality of connector assemblies adjacent the first end or first ends of the corresponding at least one assembly optical fiber to define an exposed portion of the at least one assembly optical fiber; and
repositioning the outlet fanout tubes along the respective connector assemblies so that an end of each of the outlet fanout tubes is positioned in the furcation housing.

3. The method of claim 2, further comprising repositioning the outlet fanouts tubes along the respective connector assemblies so that each of the outlet fanout tubes covers a section of the exposed portion of the corresponding at least one assembly optical fiber that extends beyond the furcation housing.

4. The method of claim 2, wherein removing the assembly jacket from each of the plurality of connector assemblies further comprises removing the assembly jacket to define an exposed portion of assembly strength members carried by each of the connector assemblies.

5. The method of claim 2, wherein positioning respective outlet fanout tubes on each of the connector assemblies further comprises, for each of the outlet fanout tubes:
inserting the first end or first ends of the corresponding at least one assembly optical fiber through the outlet fanout tube; and
sliding the outlet fanout tube along an outer surface of the corresponding connector assembly in a direction toward the first end or first ends of the of corresponding at least one assembly optical fiber.

6. The method of claim 5, wherein repositioning the outlet fanout tubes along the respective connector assemblies further comprises, for each of the outlet fanout tubes:
sliding the outlet fanout tube along the outer surface of the corresponding connector assembly in a direction toward the first end or first ends of the corresponding at least one assembly optical fiber.

7. The method of claim 1, wherein removing the protective jacket from the fiber optic cable further comprises removing the protective jacket to define an exposed portion of cable strength members carried by the fiber optic cable.

8. The method of claim 1, wherein positioning the inlet fanout tube and the furcation housing on the fiber optic cable at a location spaced from the end of the fiber optic cable further comprises:
inserting the end of the fiber optic cable through the inlet fanout tube;
inserting the end of the fiber optic cable through the furcation housing; and
sliding the inlet fanout tube and the furcation housing along an outer surface of the fiber optic cable in a direction towards the free ends of the cable optical fibers.

9. The method of claim 8, wherein repositioning the furcation housing and the inlet fanout tube along the fiber optic cable further comprises sliding the furcation housing and the inlet fanout tube along the outer surface of the fiber optic cable in a direction toward the free ends of the cable optical fibers.

10. The method of claim 1, further comprising supplying a bonding agent to the furcation housing to secure the plurality of cable optical fibers and the plurality of connector assemblies to the furcation housing.

11. The method of claim 1, wherein splicing each of the free ends of the cable optical fibers to the first end of a respective one of the assembly optical fibers includes individually splicing a single fiber of the cable optical fibers to a corresponding single fiber of the assembly optical fibers.

12. The method of claim 1, wherein splicing each of the free ends of the cable optical fibers to the first end of a respective one of the assembly optical fibers includes mass fusion splicing an optical fiber ribbon of cable optical fibers to a corresponding optical fiber ribbon of the assembly optical fibers, wherein the optical fiber ribbon of the cable optical fibers and the optical fiber ribbon of the assembly optical fibers each include a plurality of optical fibers.

13. A fiber optic cable assembly, comprising:
a fiber optic cable including a plurality of cable optical fibers and a protective jacket surrounding the plurality of cable optical fibers, wherein a portion of the protective jacket has been removed adjacent an end of the fiber optic cable to define an exposed portion of the plurality cable optical fibers, the exposed portion of the plurality of cable optical fibers defining a free end of each cable optical fiber in the plurality of cable optical fibers;
a plurality of pre-manufactured connector assemblies, each connector assembly including at least one assembly optical fiber and an optical connector coupled to the at least one assembly optical fiber, wherein each assembly optical fiber has a first end and a second end, and wherein each optical connector is coupled to the second end or second ends of the corresponding at least one assembly optical fiber;
a splicing region where the free ends of each of the plurality of cable optical fibers is spliced to the first end of a respective one of the assembly optical fibers;
a furcation housing having a first end, a second end, and an internal passage extending therebetween, wherein the plurality of cable optical fibers extends through the first end of the furcation housing, the plurality of connector assemblies extends through the second end of the furcation housing, and the splicing region is positioned in the internal passage;
a slidable inlet fanout tube having a first end, a second end, and an internal passage extending therebetween, wherein the first end of the inlet fanout tube receives the fiber optic cable and the second end of the inlet fanout tube is coupled to the first end of the furcation housing, and wherein the inlet fanout tube is slid over and covers a section of the exposed portion of the plurality of cable optical fibers that extends beyond the furcation housing; and
a bonding agent in the furcation housing to secure the plurality of cable optical fibers and the plurality of connector assemblies to the furcation housing.

14. The fiber optic cable assembly of claim 13, wherein each connector assembly of the plurality of connector assemblies further includes an assembly jacket surrounding the corresponding at least one assembly optical fiber, and wherein a portion of the assembly jacket has been removed adjacent the first end or first ends of the corresponding at least one assembly optical fiber to define an exposed portion of the at least one optical fiber, the furcation arrangement further comprising:
a plurality of outlet fanout tubes each having a first end, a second end, and an internal passage extending therebetween, wherein the first end of each outlet fanout tube in the plurality of outlet fanout tubes is positioned in the furcation housing and the second end of each outlet fanout tube in the plurality of outlet fanout tubes receives a respective one of the plurality of connector assemblies, and wherein each outlet fanout tube in the plurality of outlet fanout tubes covers a section of the exposed portion of the corresponding at least one assembly optical fiber that extends beyond the furcation housing.

15. The fiber optic cable assembly of claim 14, wherein the plurality of outlet fanout tubes are sized so as to be slidable over the connector assemblies.

16. The fiber optic cable assembly of claim 13, wherein the inlet fanout tube and the furcation housing are sized so as to be slidable over the fiber optic cable.

17. The fiber optic cable assembly of claim 13, wherein the inlet fanout tube and the furcation housing form a monolithic body.

18. The fiber optic cable assembly of claim 13, wherein the fiber optic cable includes cable strength members and the plurality of connector assemblies include assembly strength members, and wherein the cable strength members and the assembly strength members are secured within the furcation housing by the bonding agent.

19. The fiber optic cable assembly of claim 13, wherein the splicing region includes individually splicing free ends of a single fiber of the cable optical fibers to free ends of a corresponding single fiber of the assembly optical fibers.

20. The fiber optic cable assembly of claim 13, wherein the splicing region includes mass fusion splicing free ends of an optical fiber ribbon of cable optical fibers to a corresponding free ends of an optical fiber ribbon of the assembly optical fibers, wherein the optical fiber ribbon of the cable optical fibers and the optical fiber ribbon of the assembly optical fibers each include a plurality of optical fibers.

21. A kit for furcating a fiber optic cable carrying a plurality of cable optical fibers, comprising:
a slidable inlet fanout tube having a first end, a second end, and an internal passage extending therebetween, wherein the inlet fanout tube is sized so as to receive the fiber optic cable therethrough and be slidable along an outer surface of the fiber optic cable;
a slidable furcation housing having a first end, a second end, and an internal passage extending therebetween, wherein the furcation housing is sized so as to receive the fiber optic cable therethrough and be slidable along an outer surface of the fiber optic cable;
a plurality of pre-manufactured connector assemblies, each connector assembly including at least one assembly optical fiber and an optical connector coupled to the at least one assembly optical fiber, wherein each assembly optical fiber has a first end and a second end, and wherein each optical connector is coupled to the second end or second ends of the corresponding at least one assembly optical fiber; and
a plurality of outlet fanout tubes each having a first end, a second end, and an internal passage extending therebetween, wherein each of the outlet fanout tubes is sized so as to receive a respective one of the plurality of connector assemblies therethrough and be slidable along an outer surface of the respective connector assembly.

22. The kit of claim 21, wherein the inlet fanout tube and the furcation housing form a monolithic body.

23. A method of furcating an end of a fiber optic cable carrying a plurality of cable optical fibers, the method comprising:
removing a protective jacket from the fiber optic cable adjacent the end of the fiber optic cable to define an exposed portion of the plurality of cable optical fibers carried by the fiber optic cable, the exposed portion of the plurality of cable optical fibers defining a free end of each cable optical fiber in the plurality of cable optical fibers;
providing a plurality of pre-manufactured connector assemblies, each connector assembly including at least one assembly optical fiber, an optical connector coupled to the at least one assembly optical fiber, and an assembly jacket surrounding the corresponding at least one assembly optical fiber, wherein each assembly optical fiber has a first end and a second end, and wherein each optical connector is coupled to the second end or second ends of the corresponding at least one assembly optical fiber;
positioning respective outlet fanout tubes on each of the connector assemblies at a location spaced from the first end or first ends of the corresponding at least one assembly optical fiber;
splicing each of the free ends of the cable optical fibers to the first end of a respective one of the assembly optical fibers to form a splicing region;
repositioning the outlet fanout tubes along the respective connector assemblies so that an end of each of the outlet fanout tubes is positioned in the furcation housing; and
supplying a bonding agent to the furcation housing to secure the plurality of cable optical fibers and the plurality of connector assemblies to the furcation housing.

24. The method of claim 23, wherein splicing each of the free ends of the cable optical fibers to the first end of a respective one of the assembly optical fibers includes individually splicing a single fiber of the cable optical fibers to a corresponding single fiber of the assembly optical fibers.

25. The method of claim 23, wherein splicing each of the free ends of the cable optical fibers to the first end of a respective one of the assembly optical fibers includes mass fusion splicing an optical fiber ribbon of cable optical fibers to a corresponding optical fiber ribbon of the assembly optical fibers, wherein the optical fiber ribbon of the cable optical fibers and the optical fiber ribbon of the assembly optical fibers each include a plurality of optical fibers.

26. A fiber optic cable assembly, comprising:
a fiber optic cable including a plurality of cable optical fibers and a protective jacket surrounding the plurality of cable optical fibers, wherein a portion of the protective jacket has been removed adjacent an end of the fiber optic cable to define an exposed portion of the plurality cable optical fibers, the exposed portion of the plurality of cable optical fibers defining a free end of each cable optical fiber in the plurality of cable optical fibers;
a plurality of pre-manufactured connector assemblies, each connector assembly including at least one assembly optical fiber, an optical connector coupled to the at least one assembly optical fiber, and an assembly jacket surrounding the at least one assembly optical fiber, wherein:
each assembly optical fiber has a first end and a second end;
each optical connector is coupled to the second end or second ends of the corresponding at least one assembly optical fiber; and
a portion of the assembly jacket of each connector assembly has been removed adjacent the first end or first ends of the corresponding at least one assembly optical fiber to define an exposed portion of the at least one optical fiber;
a plurality of outlet fanout tubes each having a first end, a second end, and an internal passage extending therebetween;
a splicing region where the free ends of each of the plurality of cable optical fibers is spliced to the first end of a respective one of the assembly optical fibers;
a slidable furcation housing having a first end, a second end, and an internal passage extending therebetween, wherein:
the plurality of cable optical fibers extends through the first end of the furcation housing, the plurality of connector assemblies extends through the second end of the furcation housing, and the splicing region is positioned in the internal passage;
the first end of each outlet fanout tube in the plurality of outlet fanout tubes is positioned in the slidable furcation housing by sliding the slidable furcation housing over the splicing region, and the second end of each outlet fanout tube in the plurality of outlet fanout tubes receives a respective one of the plurality of connector assemblies;
each outlet fanout tube in the plurality of outlet fanout tubes covers a section of the exposed portion of the corresponding at least one assembly optical fiber that extends beyond the furcation housing; and
a bonding agent in the furcation housing to secure the plurality of cable optical fibers and the plurality of connector assemblies to the furcation housing.
